(19) United States
(12) Patent Application Publication
(10) Pub. No.: US 2026/0220191 A1
(43) Pub. Date: Jul. 30, 2026

(54) SYSTEM AND METHOD FOR SELECTING AN IMAGE

(71) Applicant: CANON KABUSHIKI KAISHA, Tokyo (JP)

(72) Inventors: Floyd Albert Maseda, Irvine, CA (US); Quentin Florian Dietz, Irvine, CA (US); Rui Xu, Irvine, CA (US)

(21) Appl. No.: 19/143,349

(22) PCT Filed: Dec. 27, 2023
(86) PCT No.: PCT/US2023/086041

§ 371 Date: Jun. 25, 2025

Related U.S. Application Data
(60) Provisional application No. 63/477,546, filed on Dec. 28, 2022.
(60) Provisional application No. 63/477,939, filed on Dec. 30, 2022.

(51) Int. Cl. G06F 16/58; G06V 40/16

(52) U.S. Cl. CPC G06F 16/58; G06V 40/175

(57) ABSTRACT

An information processing apparatus and method is provided and includes one or more memories storing instructions and storing a data structure representing a set of candidate images and feature information about each image in the candidate set of images; and one or more processors that, upon execution of the instructions, are configured to search the data structure for a target image having feature information, determine whether the feature information satisfies a predetermined criteria, select the target image satisfying the predetermined criteria; and transmit the selected image to a secondary application.

### CROSS-REFERENCE TO RELATED APPLICATIONS

This application claims the benefit of U.S. Provisional Patent Application Ser. No. 63/477,546 filed on Dec. 28, 2022 and U.S. Provisional Patent Application Ser. No. 63/477,939 filed on Dec. 30, 2022, both of which are incorporated herein in their entirety.

### BACKGROUND

### Technical Field

The present disclosure relates generally to video image processing in a virtual reality environment.

### Description of Related Art

Given the progress that has been recently made in mixed reality, it is becoming practical to use a headset or Head Mounted Display (HMD) to join a virtual conference or a get-together meeting and be able to see each other with 3D faces in real-time. The need for these gatherings has been made more important because, in some scenarios such as a pandemic or other disease outbreaks, people cannot meet together in person.

Headsets are needed so we are able to see the 3D faces of each other using virtual and/or mixed reality. However, with the headset positioned on the face of a user, no one can really see the entire 3D face of others because the upper part of the face will be blocked by the headset. Therefore, to find a way to remove the headset and recover the blocked upper face region from the 3D faces is critical to the overall performance in virtual and/or mixed reality. While there are techniques for image replacement and removal, certain difficulties exist when doing this replacement on a frame-by-frame basis. More specifically, analyzing there exists a need to quickly analyze and identify which images are used for replacement purposes in each image frame. This is a processing intensive task and a need exists to improve the ability to store and retrieve images for replacement purposes.

### SUMMARY

In one embodiment, an information processing apparatus and method is provided and includes one or more memories storing instructions and storing a data structure representing a set of candidate images and feature information about each image in the candidate set of images; and one or more processors that, upon execution of the instructions, are configured to search the data structure for a target image having feature information, determine whether the feature information satisfies a predetermined criteria, select the target image satisfying the predetermined criteria; and transmit the selected image to a secondary application.

In another embodiment, the feature information includes orientation information characterizing an orientation of an object in each image relative to an image capture device.

In another embodiment, feature information includes expression information that characterizes a particular expression of a person in the captured image.

In a further embodiment, the expression information is based on a presence and absences of one of a plurality of facial activation units.

In yet another embodiment, the predetermined criteria is based on an object in the candidate image being evaluated is within a predetermined target distance from an ideal distance.

These and other objects, features, and advantages of the present disclosure will become apparent upon reading the following detailed description of exemplary embodiments of the present disclosure, when taken in conjunction with the appended drawings, and provided claims.

### BRIEF DESCRIPTION OF THE DRAWINGS

FIG. 1 illustrates a virtual reality capture and display system according the present disclosure.

FIG. 2 shows an embodiment of the present disclosure.

FIG. 3 shows a virtual reality environment as rendered to a user according to the present disclosure.

FIG. 4 illustrates a block diagram of an exemplary system according to the present disclosure.

FIG. 5 illustrates a block diagram of an exemplary system according to the present disclosure.

FIG. 6 is a flow diagram illustrating an algorithm according to the present disclosure.

FIG. 7 is an exemplary data frame generated according to the present disclosure.

FIG. 8 is a flow diagram illustrating an algorithm according to the present disclosure.

FIG. 9 is an exemplary data frame generated according to the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

Exemplary embodiments of the present disclosure will be described in detail below with reference to the accompanying drawings. It is to be noted that the following exemplary embodiment is merely one example for implementing the present disclosure and can be appropriately modified or changed depending on individual constructions and various conditions of apparatuses to which the present disclosure is applied. Thus, the present disclosure is in no way limited to the following exemplary embodiment and, according to the Figures and embodiments described below, embodiments described can be applied/performed in situations other than the situations described below as examples. Further, where more than one embodiment is described, each embodiment can be combined with one another unless explicitly stated otherwise. This includes the ability to substitute various steps and functionality between embodiments as one skilled in the art would see fit.

### Environment Overview

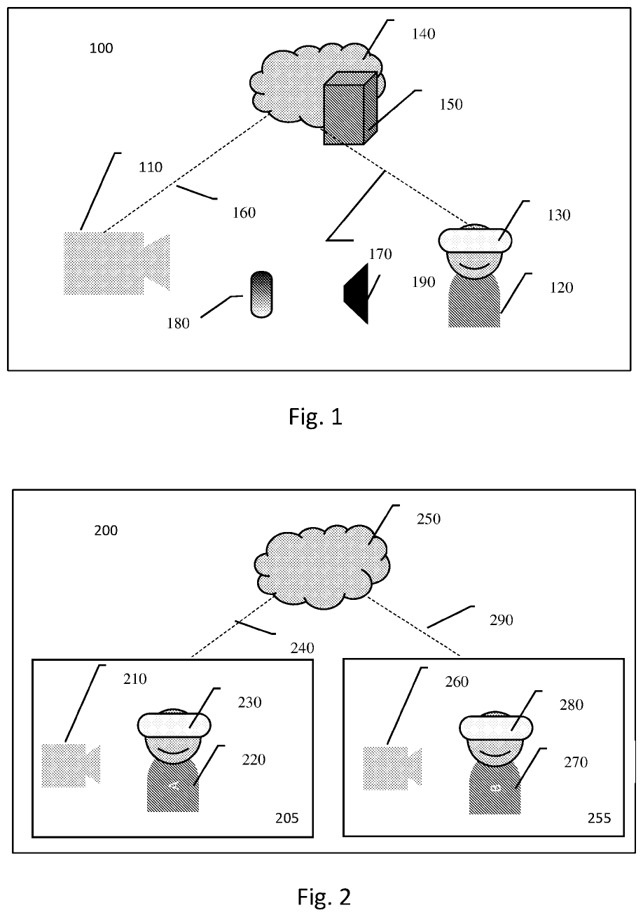

FIG. 1 shows a virtual reality capture and display system 100. The virtual reality capture system comprises a capture device 110. The capture device may be a camera with sensor and optics designed to capture 2D RGB images or video, for example. In one embodiment, the image capture device 110 is a smartphone that has front and rear facing cameras and which can display images captured thereby on a display screen thereof. Some embodiments use specialized optics that capture multiple images from disparate view-points such as a binocular view or a light-field camera. Some embodiments include one or more such cameras. In some embodiments the capture device may include a range sensor that effectively captures RGBD (Red, Green, Blue, Depth) images either directly or via the software/firmware fusion of multiple sensors such as an RGB sensor and a range sensor (e.g., a lidar system, or a point-cloud based depth sensor). The capture device may be connected via a network 160 to a local or remote (e.g., cloud based) system 150 and 140 respectively, hereafter referred to as the server 140. The capture device 110 is configured to communicate via the network connect 160 to the server 140 such that the capture device transmits a sequence of images (e.g., a video stream) to the server 140 for further processing.

Also, in FIG. 1, a user 120 of the system is shown. In the example embodiment the user 120 is wearing a Virtual Reality (VR) device 130 configured to transmit stereo video to the left and right eye of the user 120. As an example, the VR device may be a headset worn by the user. As used herein, the VR device and head mounted display (HMD) device may be used interchangeably. Other examples can include a stereoscopic display panel or any display device that would enable practice of the embodiments described in the present disclosure. The VR device is configured to receive incoming data from the server 140 via a second network 170. In some embodiments the network 170 may be the same physical network as network 160 although the data transmitted from the capture device 110 to the server 140 may be different than the data transmitted between the server 140 and the VR device 130. Some embodiments of the system do not include a VR device 130 as will be explained later. The system may also include a microphone 180 and a speaker/headphone device 190. In some embodiments the microphone and speaker device are part of the VR device 130.

FIG. 2 shows an embodiment of the system 200 with two users 220 and 270 in two respective user environments 205 and 255. In this example embodiment, each user 220 and 270 are equipped with a respective capture devices 210 and 260, respective VR devices 230 and 280, and are connected via respective networks 240 and 270 to a server 250. In some instances, only one user has a capture device 210 or 260, and the opposite user may only have a VR device. In this case, one user environment may be considered as a transmitter and the other user environment may be considered the receiver in terms of video capture. However, in embodiments with distinct transmitter and receiver roles, audio content may be transmitted and received by only the transmitter and receiver or by both, or even in reversed roles.

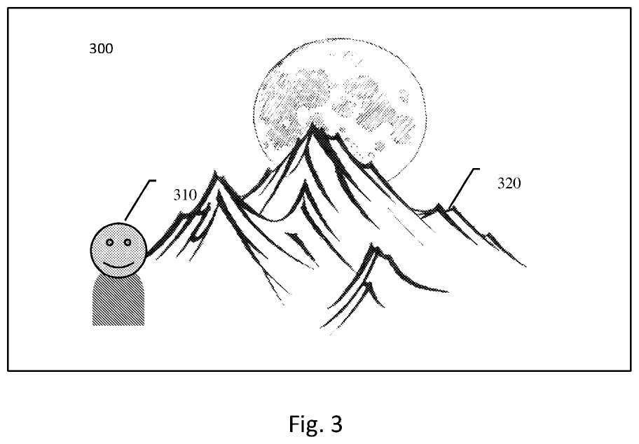

FIG. 3 shows a virtual reality environment 300 as rendered to a user. The environment includes a computer graphic model 320 of the virtual world with a computer graphic projection of a captured user 310. For example, the user 220 of FIG. 2, may see via the respective VR device 230, the virtual world 320 and a rendition 310 of the second user 270 of FIG. 2. In this example, the capture device 260 would capture images of user 270, process them on the server 250 and render them into the virtual reality environment 300.

In the example of FIG. 3, the user rendition 310 of user 270 of FIG. 2, shows the user without the respective VR device 280. The present disclosure sets forth a plurality of algorithms that, when executed, cause the display of user 270 to appear without the VR device 280 and as if they were captured naturally without wearing the VR device. Some embodiments show the user with the VR device 280. In other embodiments the user 270 does not use a wearable VR device 280. Furthermore, in some embodiments the captured images of user 270 capture a wearable VR device, but the processing of the user images remove the wearable VR device and replace it with the likeness of the users face.

Additionally, the addition of the user rendition 310 into the virtual reality environment 300 along with VR content 320 may include a lighting adjustment step to adjust the lighting of the captured and rendered user 310 to better match the VR content 320.

In the present disclosure, the first user 220 of FIG. 2, is shown via the respective VR device 230, the VR rendition 300 of FIG. 3. Thus, the first user 220, sees user 270 and the virtual environment content 320. Likewise, in some embodiments, the second user 270 of FIG. 2, will see in the same VR environment 320, but from a different view-point, e.g. the view-point of the virtual character rendition of 310 for example.

In order to achieve the immersive calling as described above, it is important to render each user within the VR environment as if they were not wearing the headset in which they are experiencing the VR content. The following describes the real-time processing performed that obtains images of a respective user in the real world while wearing a virtual reality device 130 also referred to hereinafter as the head mount display (HMD) device.

### Hardware

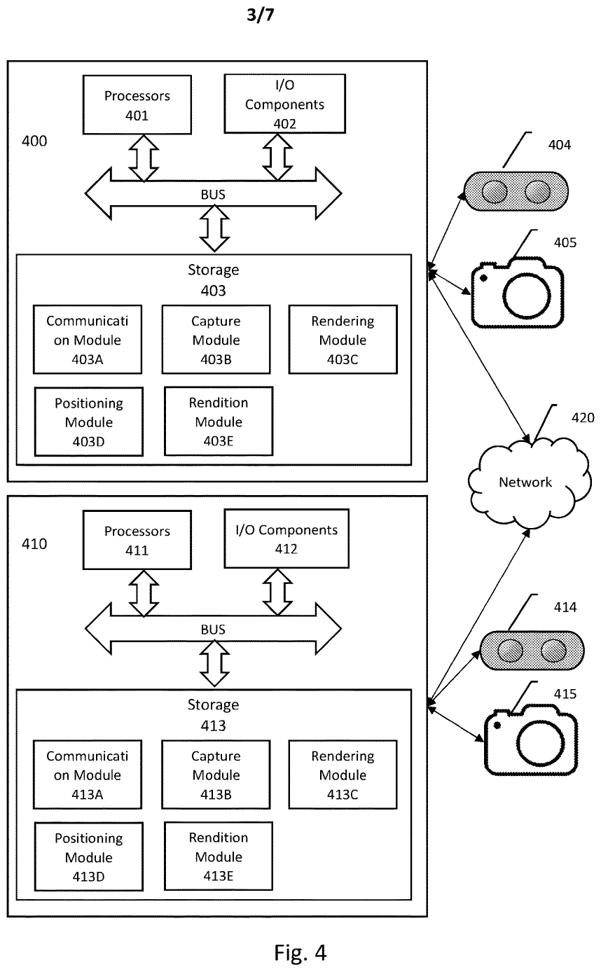

FIG. 4 illustrates an example embodiment of a system for virtual reality immersive calling system. The system includes two user environment systems 400 and 410, which are specially-configured computing devices; two respective virtual reality devices 404 and 414, and two respective image capture devices 405 and 415. In this embodiment, the two user environment systems 400 and 410 communicate via one or more networks 420, which may include a wired network, a wireless network, a LAN, a WAN, a MAN, and a PAN. Also, in some embodiments the devices communicate via other wired or wireless channels.

The two user environment systems 400 and 410 include one or more respective processors 401 and 411, one or more respective I/O components 402 and 412, and respective storage 403 and 413. Also, the hardware components of the two user environment systems 400 and 410 communicate via one or more buses or other electrical connections. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 401 and 411 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 402 and 412 include communication components (e.g., a graphics card, a network-interface controller) that communicate with the respective virtual reality devices 404 and 414, the respective capture devices 405 and 415, the network 420, and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storages 403 and 413 include one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storages 403 and 413, which may include both ROM and RAM, can store computer-readable data or computer-executable instructions.

The two user environment systems 400 and 410 also include respective communication modules 403A and 413A, respective capture modules 403B and 413B, respective rendering module 403C and 413C, respective positioning module 403D and 413D, and respective user rendition modules 403E and 413E. A module includes logic, computer-readable data, or computer-executable instructions. In the embodiment shown in FIG. 4, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage 403 and 413. Also, in some embodiments, the two user environment systems 400 and 410 includes additional or fewer modules, the modules are combined into fewer modules, or the modules are divided into more modules. One environment system may be similar to the other or may be different in terms of the inclusion or organization of the modules.

The respective capture modules 403B and 413B include operations programed to carry out image capture as shown in 110 of FIGS. 1, 210 and 260 of FIG. 2. The respective rendering module 403C and 413C contain operations programed to carry out the functionality associated with rendering images that are captured to one or more users participating in the VR environment. The respective positioning module 403D and 413D contain operations programmed to carry out the process including identifying and determining position of each respective user in the VR environment. The respective user rendition modules 403E and 413E contains operations programmed to carry out user rendering as illustrated in the following figures described hereinbelow. The prior-training module 403F contains operations programmed to estimate the nature and type of images that were captured prior to participating in the VR environment that are used for the head mount display removal processing. In some embodiments the some modules are stored and executed on an intermediate system such as a cloud server. In other embodiments, the capture devices 405 and 415, respectively, include one or more modules stored in memory thereof that, when executed perform certain of the operations described hereinbelow.

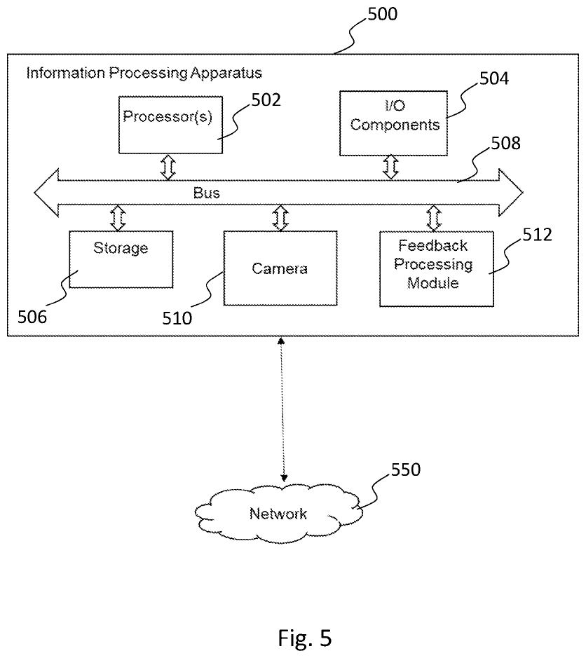

An information processing apparatus 500 is shown in FIG. 5 and performs the processing described hereinbelow with respect to obtaining one or more precapture images and generating the data frame according to invention principles. The information processing apparatus 500 is selectively connected to a network 550 such as a wired network, a wireless network, a LAN, a WAN, a MAN, and a PAN. Also, in some embodiments the devices communicate via other wired or wireless channels.

The information processing apparatus 500 includes one or more processors 502, one or more I/O components 504, and storage 506. Also, the hardware components communicate via one or more buses or other electrical connections 508. Examples of buses include a universal serial bus (USB), an IEEE 1394 bus, a PCI bus, an Accelerated Graphics Port (AGP) bus, a Serial AT Attachment (SATA) bus, and a Small Computer System Interface (SCSI) bus.

The one or more processors 502 include one or more central processing units (CPUs), which may include one or more microprocessors (e.g., a single core microprocessor, a multi-core microprocessor); one or more graphics processing units (GPUs); one or more tensor processing units (TPUs); one or more application-specific integrated circuits (ASICs); one or more field-programmable-gate arrays (FPGAs); one or more digital signal processors (DSPs); or other electronic circuitry (e.g., other integrated circuits). The I/O components 504 include communication components (e.g., a graphics card, a network-interface controller) that communicate with the head mount display apparatus, the network and other input or output devices (not illustrated), which may include a keyboard, a mouse, a printing device, a touch screen, a light pen, an optical-storage device, a scanner, a microphone, a drive, and a game controller (e.g., a joystick, a gamepad).

The storage 506 includes one or more computer-readable storage media. As used herein, a computer-readable storage medium includes an article of manufacture, for example a magnetic disk (e.g., a floppy disk, a hard disk), an optical disc (e.g., a CD, a DVD, a Blu-ray), a magneto-optical disk, magnetic tape, and semiconductor memory (e.g., a non-volatile memory card, flash memory, a solid-state drive, SRAM, DRAM, EPROM, EEPROM). The storage 1003, which may include both ROM and RAM, can store computer-readable data or computer-executable instructions.

The information processing apparatus 500, as shown herein, includes a camera 510 and all associated hardware and software that controls the image capture processing. The image data captured includes both still image data and video image data. The captured image data is stored in the storage 506 and can be made accessible to any other components of the information processing apparatus 500.

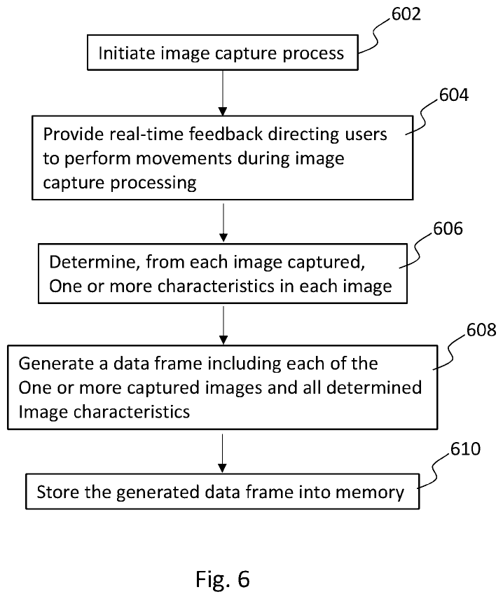

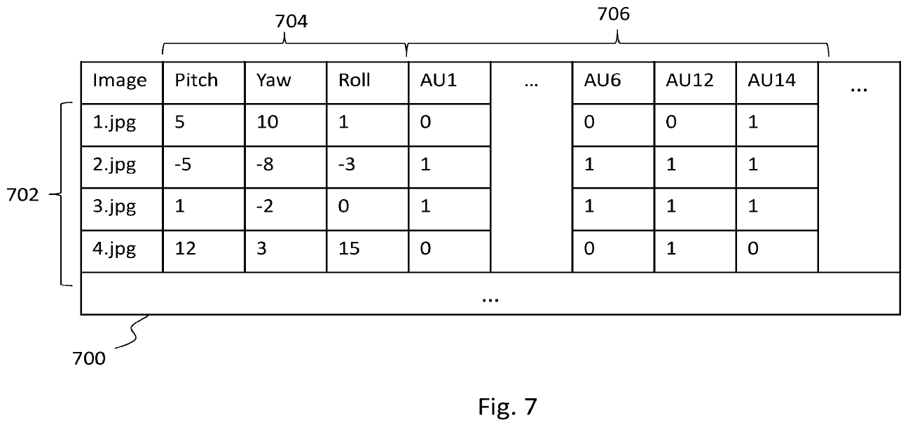

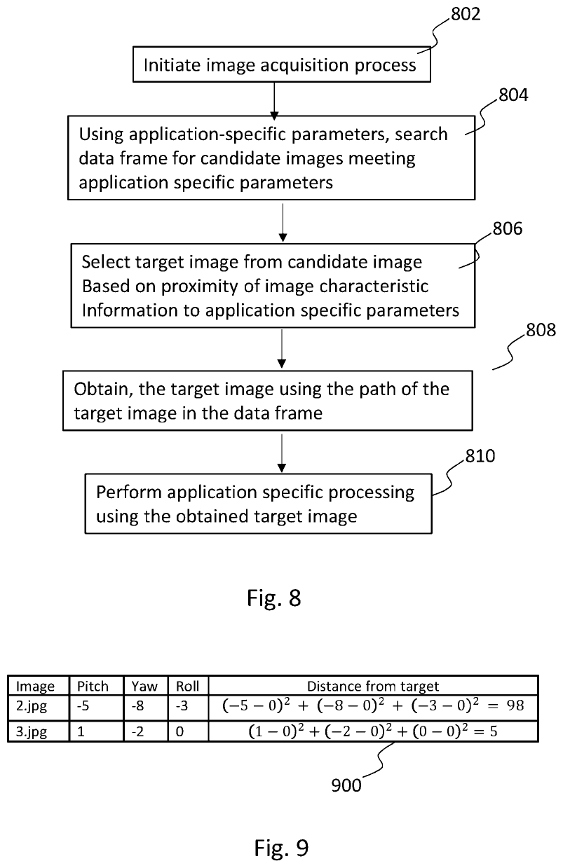

The information processing apparatus 500 includes a feedback processing module 512 that performs the functions described hereinabove. In one embodiment, the feedback module 512 includes a set of instructions that controls the information processing apparatus 500 to obtain, analyze, process and store a plurality images of a subject into a data frame as described in FIG. 6 and FIG. 7. In another embodiment, the feedback module 512 includes further processing that uses the generated data frame in FIG. 7 and the instructions in FIG. 8 to obtain candidate images based on particular image characteristics as shown in FIG. 9. A module includes logic, computer-readable data, or computer-executable instructions. In the embodiment shown in FIG. 5, the modules are implemented in software (e.g., Assembly, C, C++, C#, Java, BASIC, Perl, Visual Basic, Python, Swift). However, in some embodiments, the modules are implemented in hardware (e.g., customized circuitry) or, alternatively, a combination of software and hardware. When the modules are implemented, at least in part, in software, then the software can be stored in the storage.

### Data Structure and Associated Processing

In order to effect the image replacement and display in the VR environment described above, the present disclosure describes an apparatus and method that makes use of one or more pre-captured images in or to select one image from a set of candidate images. Often times it is desirous to capture a comprehensive collection of images that contain a plurality of different visual characteristics of the object being captured. The present disclosure advantageously provides a data structure that organizes and stores a set of candidate images with one or more image characteristics that are associated with each image and can evaluate which of the candidate images should be selected for a particular purpose. This data structure advantageously improves the speed at which candidate images can be identified from a large number of precaptured images and further improves the likelihood that the retrieved candidate image has the correct features associated therewith. The data frame and associated processing described herein improves the ability to identify and retrieve the candidate image more quickly. A quicker selection processing reduces the lag or any latency within the VR environment because the processing time needed to obtain and replace the image is decreased thereby providing near real-time interaction between two users in a VR environment that allows each to see the other as if they were not wearing the HMDs where the VR environment is being displayed.

In one embodiment, the processing for capturing images to be stored in the data frame according to the present disclosure is shown in FIG. 6. Exemplary operation will be described herein with respect to the object being captured being a face of a user and the one or more characteristics being identified or otherwise recognized from the captured image include, but are not limited to, any of face orientation, head orientation, eye gaze, or any orientation of any facial feature. In other embodiments, based on image processing performed by a trained machine learning model trained on a plurality of images that are labeled with known facial expressions such that the model can recognize aspects of captured images as corresponding to known face expressions, images can be characterized according to one or more emotions as determined from the facial expressions in the captured image. The human face and the multitude of expressions able to be expressed poses difficulty in determining which image from a set of candidate images meet a particular criteria and are selected for a particular purpose. This is particularly difficult when considering real-time visual communication with others such as shown in FIG. 2 because the various facial expression can differ and change rapidly during the course of non-structured communication between users. As such, the following processing resolves this problem by both captured and storing in a data frame a plurality of candidate images such that they can quickly be parsed and obtained and then used for replacement during HMD removal and replacement processing.

In one embodiment, as shown in FIG. 6, these precaptured images that comprise the set of candidate images are obtained via a precapture process. In step 600, image capture processing of the user is initiated and in step 604, a user is directed by following instructions on a graphical user interface (GUI), to move the desired area to be captured (e.g. the face/head) in predetermined manner to ensure a robust and complete set of images are captured. In step 606, these images are processed to identify and make use of facial feature data in further image processing applications. The set of candidate images are obtained based on real-time directive feedback provided to a user during the image capturing process which causes an image capture device to operate in a reactive manner so that an image capture guide being displayed on a display of the image capture device is directly responsive to the user's movement. This has the further advantage of making sure that the images being captured provide the level of detail sufficient to obtain one or more facial features or characteristics therefrom.

As images are recorded during the precapture stage, a data frame is generated in step 608 whereby the images or references to the images (e.g. a file path) are stored in a storage device and saved into a data structure such as a DataFrame in step 610. The DataFrame also includes characteristic information for each image that has been extracted. The characteristic information, includes but is not limited to, orientation information, facial expression information, blink detection information. The characteristic information may include any information that can be derived from the captured image and which describes one or more aspects or one or more features of the object (e.g. face) in the captured image. This DataFrame can then serve as a central database of all precapture images, allowing for, e.g., a quick lookup of an individual image, easy filtering of images meeting certain criteria. An exemplary data frame generated and stored in accordance with FIG. 6 is shown in FIG. 7.

In exemplary operation as shown in FIG. 7, the data frame 700 which is stored in memory (e.g. a storage device), includes a plurality of user images 702 and contains at least first characteristic information 704 associated with the respective image and second characteristic information 706 associated with the respective image. In one embodiment, first characteristic information includes orientation information (i.e., pitch, yaw, and roll) of the user's head and the second characteristic information includes expression information representing presence or absence of points on a user's face that correspond to a particular type of facial expression. In one embodiment, the expression information is presented in the form of facial action units (FAUs). During the capture process information may be arranged in DataFrame 700 where each row 702 contains a path to the image, as well values of first characteristic information 703 and second characteristic information 706. In one embodiment, values for the first characteristic information are numerical indicators for orientation of a face/head of a user. In this embodiment, first characteristic information includes numerical values representing degrees (plus or minus) from a camera-facing pose (0 degrees). Additionally, values for the second characteristic information 706 are binary values indicating that respective type of second characteristic is present (1)/not present (0) values. In an exemplary embodiment, the second characteristic information 706 represents facial activation units and each type of second characteristic information represents a respective one of fourteen facial activation units. As such, each image can include values indicating that one or more different types of facial activation units are present based on the captured image.

In other embodiments, other characteristic information associated with the image can be stored thereby allowing for the quick retrieval of candidate images. In these other embodiments, the other characteristic information includes but is not limited to binary representation of eye features (e.g. open or closed), image quality characteristic information (e.g. blurry, out of focus, etc). These other types of characteristic information are described for purposes of example only and any significant feature derivable from a captured image can be quantified and stored in Data Frame 700.

FIG. 8 is a flow diagram detailing algorithm processing of obtaining, by a particular application, a target image. In step 802, a particular application executing on a processing device (e.g. information processing apparatus) initiates image acquisition processing. In step 804, the application that has initiated image acquisition process uses application-specific parameters to search the data frame 700 for candidate images meeting the application-specific parameters. In step 806, a target image is selected from the plurality of candidate images using the data frame based on proximity of the first and/or second characteristic information associated with the target image in relation to the application specific parameters. In step 808, the selected target image is obtained by the application using the path information of the selected image and the target image provided to the application for application specific processing in step 810.

In an exemplary operation, the steps of FIG. 8 can be described with respect to an application that seeks to obtain an image expressing happiness. A common indication of happiness is the coexpression of action units 6 (cheek raiser), 12 (lip corner puller), and 14 (dimpler). As such, these indicators represent the application specific parameters used to parse or search the data frame for candidate images. If the application requires an image having a happy expression, the application which requires the image can perform a filtering search based on the presence or absence of these FAUs (e.g. second characteristic information). In the data frame 700 in FIG. 7, only images 2.jpg and 3.jpg are labelled as expressing all three requisite FAUs, and are identified as candidate images from which the target image can be selected. This results in other images form data frame 700 being filtered out of the database for the purposes of the ensuing search. In certain embodiments, none of the images may include positive values of all second characteristic information. In this case, if no images depict coexpression of all three FAUs, the application specific parameters may include a precedence value that is assigned to a respective one of the second characteristic information values, for example, the precedence value may be assigned whereby AU12 is determined to be the most indicative of a happy expression, even if AU6 or AU14 are not expressed. This progressively weakens the filtering until a nonzero number of potential images is found. The description provided herein regarding FAUs and happiness is described for purpose of example only. An exemplary listing of FAUs that can be stored in the data frame are shown in table 1 below:

TABLE 1
Exemplary FAUs

| AU | |
|---|---|
| number | FACS name |
| 0 | Neutral face |
| 1 | Inner brow raiser |
| 2 | Outer brow raiser |
| 4 | Brow lowerer |
| 5 | Upper lid raiser |
| 6 | Cheek raiser |
| 7 | Lid tightener |
| 8 | Lips toward each |
| | other |
| 9 | Nose wrinkler |
| 10 | Upper lip raiser |
| 11 | Nasolabial deepener |
| 12 | Lip corner puller |
| 13 | Sharp lip puller |
| 14 | Dimpler |
| 15 | Lip corner depressor |
| 16 | Lower lip depressor |
| 17 | Chin raiser |
| 18 | Lip pucker |
| 19 | Tongue show |
| 20 | Lip stretcher |
| 21 | Neck tightener |
| 22 | Lip funneler |
| 23 | Lip tightener |
| 24 | Lip pressor |
| 25 | Lips part |
| 26 | Jaw drop |
| 27 | Mouth stretch |
| 28 | Lip suck |

Moreover, other examples of application specific parameters that make use of various presence or absence of FAUs includes aspects of the Facial Coding System whereby various expressions are correlated with the presence and/or absence of FAUs as noted herein.

In another embodiment, in addition to the second characteristic information representing a type of expression, the application specific parameters includes the first characteristic information representing orientation of the face of the user in the candidate image. Thus, once the database is satisfactorily filtered to meet the application's target requirements, orientation of the person's face is important for application specific processing. In one embodiment, the application specific parameters require the face of the user to look directly at the camera. Thus, the application specific parameter for orientation requires that the candidate image having first characteristic information (e.g. orientation information) “closest” to an orientation values of 0 in all three of pitch, yaw, and roll. One embodiment of the search may use a simple Euclidean distance between the target orientation (0,0,0) and each of the filtered image's orientations. FIG. 9 illustrates exemplary results of the processing of FIG. 8 whereby after filtering based on second characteristic information (e.g. FAU expression), a processed data frame 900 remains with only rows for image 2.jpg and 3.jpg. The “distance from target” value for each image is calculated from the pitch, yaw, and roll values and the target orientation and image 3.jpg has the distance from target closest to 0, it is considered to be the better match and thus is selected for application specific processing.

Other filtering passes may occur based on other characteristics of the image if that information is contained in the database. For example, if the images are labelled with whether or not the person's eyes are open, whether the image is blurry or focused, or any other significant feature.

In some embodiments, such as but not limited to those where FAU expression is not binary but rather continuous or discrete values depending on intensity of expression or those where other continuous features are present, this distance may include more than the three orientation components as the target and for each image. Some embodiments also contain a weighting to prioritize some components over others, e.g., yaw may be the most important angle to emphasize while roll may be de-emphasized by attaching a lower weight to it in the distance calculation. Still further embodiments may use some other metric besides Euclidean distance to determine the distance from the target.

In one embodiment, the application referenced in FIG. 8 is the applications described above in FIGS. 1-4 whereby a set of precaptured images are provided to a virtual reality processing server which is configured to perform image processing whereby a user wearing a head mount display (HMD) device has their image captured by an image capture device but, for purposes of display, the captured image is modified to remove the HMD and replace an area of the captured image containing the HMD with a corresponding portion of an image of the user that was captured before the HMD was ever put on by the user. This is known as HMD removal and is described herein above with respect to FIGS. 1-4. During HMD removal processing, a search through the database is performed according to predetermined criteria to select an image from the candidate images. In one embodiment, the predetermined criteria (e.g. application specific parameters) include at least that (1) the image does not depict the user blinking, and (2) the extracted orientation of the image is the closest match to the current orientation of the live image. The closest orientation match may be determined using the Euclidean norm of the difference between pitch, yaw, and roll for the live image and the precapture image. This is merely one metric for closest comparison processing and others may be used.

In another embodiment, the application specific processing includes an application executing on a mobile phone (e.g. information processing apparatus) whereby the set of candidate images and the associated DataFrame that organizes the set may also be used to generate of a default profile picture for a user. In an exemplary embodiment, the DataFrame includes facial expression information and the query processing is filtered according to facial expression information. In one example, the facial expression information is set as a default to identify images of a user making one particular facial expression. The one particular facial expression may include any of happy faces and/or only neutral faces. In other embodiments, the filter processing can be set to exclude all images having a predetermined facial expression such as sad faces. Then a similar search as described in the previous paragraph may be performed on this filtered database to ensure that the user is oriented towards the camera, or toward any predetermined orientation, and other quality checks may be performed to guarantee clarity, lighting, contrast, etc., are suitable. One or more best matches may be saved and applied as potential default profile pictures for the user and used in various contexts to represent the user, e.g., if they have not already uploaded a profile picture of their own choosing.

At least some of the above-described devices, systems, and methods can be implemented, at least in part, by providing one or more computer-readable media that contain computer-executable instructions for realizing the above-described operations to one or more computing devices that are configured to read and execute the computer-executable instructions. The systems or devices perform the operations of the above-described embodiments when executing the computer-executable instructions. Also, an operating system on the one or more systems or devices may implement at least some of the operations of the above-described embodiments.

Furthermore, some embodiments use one or more functional units to implement the above-described devices, systems, and methods. The functional units may be implemented in only hardware (e.g., customized circuitry) or in a combination of software and hardware (e.g., a microprocessor that executes software).

Additionally, some embodiments of the devices, systems, and methods combine features from two or more of the embodiments that are described herein. Also, as used herein, the conjunction “or” generally refers to an inclusive “or,” though “or” may refer to an exclusive “or” if expressly indicated or if the context indicates that the “or” must be an exclusive “or.”

While the present disclosure has been described with reference to exemplary embodiments, it is to be understood that the invention is not limited to the disclosed exemplary embodiments.

1. An information processing apparatus comprising
one or more memories storing instructions and storing a data structure representing a set of candidate images and feature information about each image in the candidate set of images; and
one or more processors that, upon execution of the instructions, are configured to:
search the data structure for a target image having feature information;
determine whether the feature information satisfies a predetermined criteria;
select the target image satisfying the predetermined criteria; and
transmit the selected image to a secondary application,
wherein the feature information are a plurality of facial activation units characterizing particular expressions of a person in the captured image.

2. The information processing apparatus of claim 1, wherein the feature information includes orientation information characterizing an orientation of an object in each image relative to an image capture device.

3. (canceled)

4. (canceled)

5. The information processing apparatus of claim 1, wherein the predetermined criteria is based on an object in the candidate image being evaluated being within a predetermined target distance from an ideal distance.

6. An information processing method performed on a data structure stored in memory representing a set of candidate images and feature information about each image in the candidate set of images, the method comprising
searching the data structure for a target image having feature information;
determining whether the feature information satisfies a predetermined criteria;
selecting the target image satisfying the predetermined criteria; and
transmitting the selected image to a secondary application,
wherein the feature information are a plurality of facial activation units characterizing particular expressions of a person in the captured image.

7. The method of claim 6, wherein the feature information includes orientation information characterizing an orientation of an object in each image relative to an image capture device.

8. (canceled)

9. (canceled)

10. The method of claim 6, wherein the predetermined criteria is based on an object in the candidate image being evaluated being within a predetermined target distance from an ideal distance.

11. A non-transitory computer readable storage medium storing instructions that, when executed by one or more processors of an information processing apparatus, configures the information processing apparatus to perform a method according to claim 6.

12. The information processing apparatus of claim 1, wherein determining whether the predetermined criteria is satisfied is based on a combination of the plurality of facial activation units corresponding to a particular expression.

13. The information processing apparatus of claim 1, wherein when no target image exactly satisfies the predetermined criteria, the processors are further configured to assign precedence values to specific facial activation units and select a target image based on the precedence values.

14. The information processing apparatus of claim 1, wherein the feature information further includes eye state information indicating whether eyes are open or closed in each image, and the predetermined criteria include a condition that the eyes are open.

15. The information processing apparatus of claim 1, wherein the feature information further includes image quality metrics for each image, and the predetermined criteria include thresholds for image clarity, focus, or lighting conditions.

16. The information processing method of claim 6, wherein determining whether the predetermined criteria is satisfied is based on a combination of the plurality of facial activation units corresponding to a particular expression.

17. The information processing method of claim 6, further comprising assigning precedence values to specific facial activation units when the combination of facial activation units does not exactly match the predetermined criteria.

18. The information processing method of claim 6, wherein the feature information further includes eye state information indicating whether eyes are open or closed in each image, and the predetermined criteria include a condition that the eyes are open.

19. The information processing method of claim 6, wherein the feature information further includes image quality metrics for each image, and the predetermined criteria include thresholds for image clarity, focus, or lighting conditions.
